(19) United States
(12) Patent Application Publication
(10) Pub. No.: US 2012/0077545 A1
(43) Pub. Date: Mar. 29, 2012

(54) MOBILE TERMINAL AND CONTROL METHOD

(75) Inventors: Tae Jong KIM, Seoul (KR); Seung Woo NAM, Namyangju-si (KR)

(73) Assignee: PANTECH CO., LTD., Seoul (KR)

(21) Appl. No.: 13/005,985

(22) Filed: Jan. 13, 2011

(30) Foreign Application Priority Data
Sep. 29, 2010 (KR) 10-2010-0094080

(51) Int. Cl. H04W 80/04; H04W 88/02

(52) U.S. Cl. 455/558

(57) ABSTRACT

A mobile terminal includes a subscriber identification module (SIM) card unit to receive and store Internet Protocol (IP) device information including a local IP address of an IP device from a femtocell, and a control unit to transmit a control command to control the IP device using the local IP address.

### CROSS-REFERENCE TO RELATED APPLICATION

This application claims priority from and the benefit of Korean Patent Application No. 10-2010-0094080, filed on Sep. 29, 2010, which is hereby incorporated by reference for all purposes as if fully set forth herein.

### BACKGROUND

1. Field

Exemplary embodiments of the present invention relate to a mobile terminal to store a local Internet Protocol (IP) address of an IP device in a subscriber identification module (SIM) card of the mobile terminal, and to control the IP device using the stored local IP address, and a method for controlling an IP device.

2. Discussion of the Background

With the recent appearance of various high-speed data service systems, for example High-Speed Downlink Packet Access (HSDPA) and Worldwide Interoperability for Microwave Access (WiMAX), mobile communication services have expanded to provide wireless data services. However, since the high-speed data service system commonly enables several hundred users located within the coverage of a base station to share a limited channel capacity, downloading speed may be considerably decreased for individual users.

Thus, with the advancement in semiconductor technology, a femtocell has been developed. A femtocell refers to a personal base station provided for use in a home or small business so as to provide a service to a few users. The term “femtocell” is a compound word of “femto” denoting a factor of 10⁻¹⁵ and a “cell” denoting a service area unit of one base station in mobile communication, and refers to a base station for providing a service in an area considerably smaller than the existing mobile communication service area. A mobile terminal can perform wired/wireless communications using the femtocell.

### SUMMARY

Exemplary embodiments of the present invention provide a mobile terminal to store a local Internet Protocol (IP) address of an IP device in a subscriber identification module (SIM) card of the mobile terminal and to control the IP device using the stored local IP address. Exemplary embodiments of the present invention also provide a method for controlling an IP device using a mobile terminal. Communications between the mobile terminal and IP device may be through a femtocell.

Additional features of the invention will be set forth in the description which follows, and in part will be apparent from the description, or may be learned by practice of the invention.

Exemplary embodiments of the invention disclose a mobile terminal including: a subscriber identification module (SIM) card unit to receive and store Internet Protocol (IP) device information comprising a local IP address of an IP device from a femtocell; and a control unit to transmit a control command to the femtocell, the control command to control the IP device using the local IP address of the IP device.

Exemplary embodiments of the invention also disclose a method for controlling an Internet Protocol (IP) device using a mobile terminal, the method including: receiving IP device information comprising a local IP address of the IP device from a femtocell; storing the IP device information in the SIM card; and controlling the IP device using the local IP address.

Exemplary embodiments of the invention also disclose a method for controlling an Internet Protocol (IP) device using a mobile terminal, the method including: storing a local IP address of the IP device in a subscriber identification module (SIM) card, retrieving the local IP address of the IP device, and transmitting a control command to the femtocell, the control command to control the IP device using the local IP address.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram showing the configuration of a mobile terminal according to an exemplary embodiment.

FIG. 2A and FIG. 2B are diagrams showing network configurations of a mobile terminal, a femtocell and an IP device according to exemplary embodiments.

FIG. 3 is a diagram showing a method for controlling an IP device using a mobile terminal according to an exemplary embodiment.

FIG. 4 is a diagram showing a method for communicating among a mobile terminal, a femtocell and an IP device according to an exemplary embodiment.

FIG. 5 is a diagram showing information stored in an SIM card of a mobile terminal according to an exemplary embodiment.

### DETAILED DESCRIPTION OF THE ILLUSTRATED EMBODIMENTS

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments. In the drawings, the size and relative sizes of layers and regions may be exaggerated for clarity. Like reference numerals in the drawings denote like elements.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

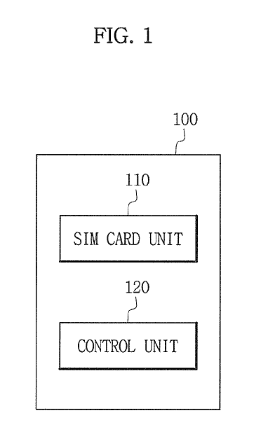

FIG. 1 is a diagram showing the configuration of a mobile terminal according to an exemplary embodiment.

Referring to FIG. 1, the mobile terminal 100 includes a subscriber identification module (SIM) card unit 110 and a control unit 120. The mobile terminal 100 also may include a radiofrequency (RF) transceiver (not shown) to send and receive data to and from a communication network, which may include a base station, a femtocell, and/or a WiFi access point.

The SIM card unit 110 receives IP device information including a local IP address of an IP device or femtocell information from a femtocell, and updates and stores the received information in the SIM card unit 110. The femtocell is a mobile communication base station for use in a smaller area, for example a home of a user. It covers an area smaller than the common mobile communication base station service area, but can provide various multimedia services to enable the user to use the various multimedia services. According to the 3rd Generation Partnership Project (3GPP) standard, IP devices connected to the femtocell perform communication using local IP addresses, which may be allocated by the femtocell. This communication scheme may be referred to as local IP access scheme. The femtocell may perform a function of allowing the mobile terminal to exchange IP packets with the IP device connected to the femtocell of the house or the region of the user, through the local IP access. The IP device may be a printer, a media server, a personal computer (PC), or another type of IP-compatible device, such as a multimedia device like a television. The SIM card unit 110 refers to an integrated circuit (“IC”) module for encrypting and storing information requested by a service provider. The mobile terminal includes the SIM card unit 110 to store information. The information may include information that is specific to the user, for example information sufficient to identify the user or the user's account, or may be more general information. The mobile terminal 100 receives one or more pieces of IP device information and femtocell information from the femtocell and stores the information in the SIM card unit 110, thereby establishing a network with the femtocell or the IP device using the SIM card unit 110 without having to equip an additional function to the mobile terminal 100. Storage in the SIM Card unit 110 may be performed by storing data in a SIM card included in the SIM Card unit 110, or another memory device. In more detail, the mobile terminal 100 may store in an Elementary Field (EF) field a local IP address included in the IP device information. The EF field is a field in which an application file for performing functions of the SIM card unit 110 is stored. The specialized information which may be stored in the EF field of the SIM card unit 110 may include the femtocell information including the ID of the femtocell, a global IP address, and the like received from the femtocell, and the IP device information including the name of the IP device, the local IP address of the IP device, the state of the IP device, and the like. The SIM card unit 110 may further include an application toolkit in which an application is stored, and the mobile terminal 100 may display the information stored in the SIM card unit 110 using the application toolkit without having to execute an additional function. A user may select an IP device according to the information displayed using the application toolkit. The SIM card unit 110 may receive the IP device information from the femtocell through Short Message Service Point to Point (SMS-PP), which may reduce the load of the mobile terminal 100. In addition, the SIM card unit 110 may receive the IP device information from the femtocell if a predetermined event occurs. The event may be set variously by the user in order to specify timing for updating the information stored in the SIM card. For example, the event may include power-on of the mobile terminal 100, the elapse of a predetermined period, or connection of a new IP device to the femtocell. The femtocell may be replaced with an IP sharing router.

The control unit 120 may transmit a control command to the femtocell or the IP device using the local IP address stored in the SIM card unit 110. In detail, the control unit 120 may transmit a control command directly to the IP device or through the femtocell using the local IP address of the IP device received through communication with the femtocell. The mobile terminal 100 may transmit a control command using the local IP address received from the femtocell within the coverage in which communication is possible through the femtocell, or outside the coverage of the femtocell. The control command may be a command to control the IP device. As used herein, “control” of the IP device by the control unit 120 may include performing any operation or function that could be performed locally by or on the IP device. For example, the control command could wake up a PC from a sleep mode, or could establish and manage a data sharing operation between the IP device and the mobile terminal 100 or a third device. In another example, where the IP device is a printer, the control command could include a command for the printer to print information or a file transmitted from the mobile terminal 100.

The control unit 120 may receive control information for controlling an IP device through the femtocell together with the IP device information and may control the IP device using the received control information. If IP device information for multiple IP devices is received from the femtocell, the control unit 120 may specify an IP device to be controlled using a local IP address to control the IP device. If the application toolkit is stored in the SIM card unit 110, the control unit 120 may display the information stored in the SIM card unit 110 using the application toolkit to perform only an information transmission function, which may reduce a network load.

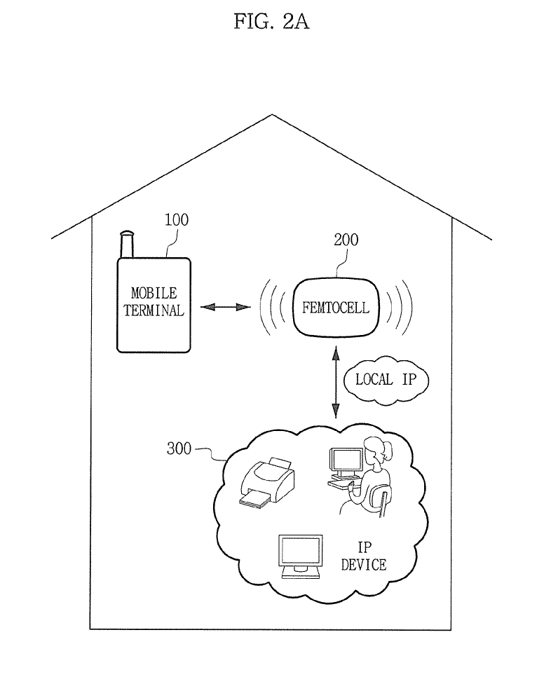

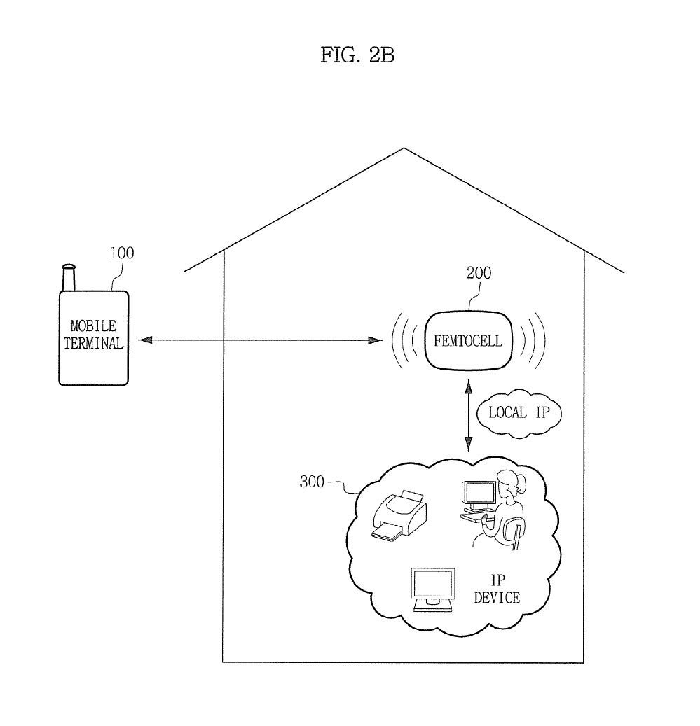

FIG. 2A and FIG. 2B are diagrams showing network configurations of a mobile terminal, a femtocell and an IP device according to an exemplary embodiment.

FIG. 2A shows a network configuration in which the mobile terminal 100 performs communication within the coverage of the femtocell 200, and FIG. 2B shows a network configuration in which the mobile terminal 100 performs communication outside the coverage of the femtocell 200. Referring to FIGS. 2A and 2B, the mobile terminal 100 may receive the local IP address of one or more IP devices 300 from the femtocell 200, may store the local IP address in the SIM card, and may transmit the control command to control a first IP device 300 through the femtocell 200 using the local IP address stored in the SIM card for the first IP device 300. The mobile terminal 100 may control the first IP device 300 using the local IP address if the mobile terminal 100 is located within the coverage of the femtocell 200, such as in FIG. 2A, or outside the coverage of the femtocell 200, such as in FIG. 2B. If the mobile terminal 100 is outside the coverage of the femtocell 200, the mobile terminal 100 may transmit the control command to the femtocell 200 via a base station (not shown) servicing the mobile terminal 100.

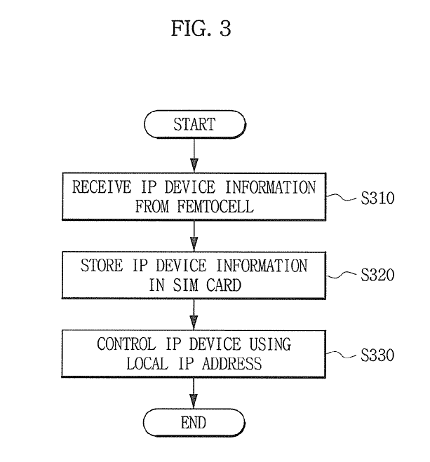

FIG. 3 is a diagram showing a method for controlling an IP device using a mobile terminal according to an exemplary embodiment.

Referring to FIG. 3, a mobile terminal receives the IP device information including the local IP address of the IP device from the femtocell (S310), stores the received IP device information in a SIM card of the mobile terminal (S320), and controls the IP device using the local IP address of the IP device information stored in the SIM card (S330). The mobile terminal can control the IP device using the local IP address stored in the SIM card when the mobile terminal is located outside the coverage of the femtocell as well as when the mobile terminal is located within the coverage of the femtocell. The mobile terminal may receive the IP device information including the local IP address from the femtocell through SMS-PP, which may reduce the load of the mobile terminal. If the application toolkit is further stored in the SIM card, the mobile terminal may display the information stored in the SIM card using the application toolkit stored in the SIM card and may control the IP device using the displayed information. When an event occurs, for example, when the mobile terminal 100 is powered on, when a predetermined period has elapsed, or when a new IP device is connected to the femtocell, the mobile terminal may receive the IP device information from the femtocell and update and store the information stored in the SIM card. Other events may be identified by default, by the network, or may be established by a user.

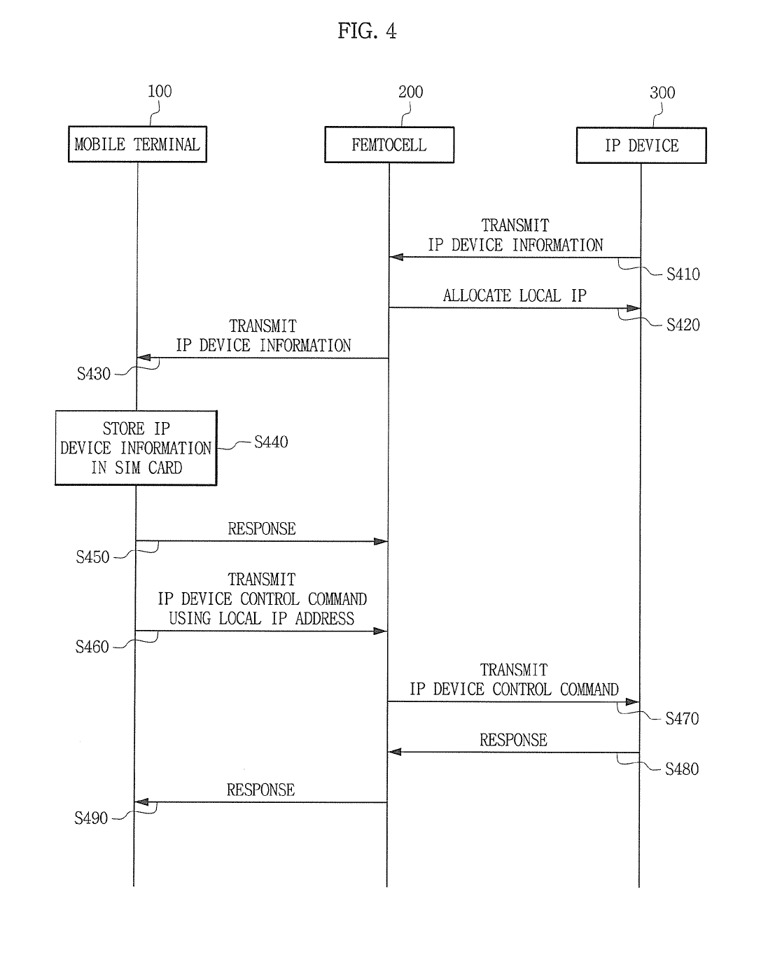

FIG. 4 is a diagram showing a method for communicating among a mobile terminal, a femtocell and an IP device according to an exemplary embodiment.

Referring to FIG. 4, the IP device 300 may be connected to the femtocell 200 and transmits the IP device information to the femtocell 200 (S410). The femtocell 200 allocates the local IP address to the IP device 300 (S420). The femtocell 200 transmits the IP device information including the local IP address of the IP device 300 to the mobile terminal 100 (S430). The IP device information may be transmitted through SMS-PP or may be transmitted when a certain event occurs. The event may be set by the user or may be a default event. The mobile terminal 100 which receives the IP device information including the IP address of the IP device 300 updates and stores the IP device information in the SIM card (S440), and transmits to the femtocell a response signal indicating that the IP device information has been received (S450).

The response signal sent at S450 may also indicate other information, for example whether the IP device information has been stored, whether the IP device information conflicts with or is inconsistent with IP device information previously stored in the SIM card for the IP device 300 or for another IP device, whether the SIM card does not have sufficient memory space to store the IP device information, whether the IP device information will be overwritten or scheduled for overwriting on the SIM card at a certain time or upon an event, or whether there was an error receiving, storing, or using the IP device information. Similarly, the mobile terminal 100 may send the response at S450 to transmit information to the femtocell 200 for establishing an event at the femtocell 200 upon which updating or retransmitting of the IP device information may occur. This process of transmitting the response at S450 may be set to be executed automatically, without requiring the instruction of the user.

If control of the IP device 300 connected to the femtocell 200 is desired, the mobile terminal 100 specifies the local IP address of the IP device 300 to be controlled and transmits a control command to the femtocell 200 (S460), and the femtocell 200 transfers the control command to the IP device 300 corresponding to the control command of the mobile terminal 100 (S470). The IP device 300 which receives the control command executes the control command and transmits the executed result as a response signal (S480), and the femtocell 200 transfers the response signal of the IP device 300 to the mobile terminal 100 (S490). Thereafter, if the IP device 300 is disconnected from the femtocell 200, the IP device information may be transmitted to the mobile terminal 100, thereby updating the IP device information stored in the SIM card.

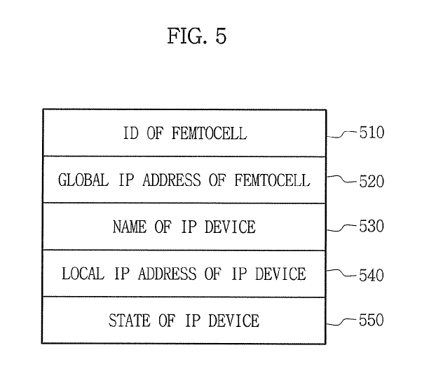

FIG. 5 is a diagram showing information stored in a SIM card of a mobile terminal according to an exemplary embodiment.

Referring to FIG. 5, the information which may be stored in the EF field of the SIM card of the mobile terminal may include the femtocell information and the IP device information. The femtocell information may include ID information 510 of the femtocell and the information 520 about the global IP address of the femtocell. In addition, the IP device information may include the name 530 of the IP device, the local IP address 540 of the IP device and the state information 550 of the IP device.

While the exemplary embodiments have been shown and described, it will be understood by those skilled in the art that various changes in form and details may be made thereto without departing from the spirit and scope of this disclosure as defined by the appended claims and their equivalents.

In addition, many modifications can be made to adapt a particular situation or material to the teachings of this disclosure without departing from the scope thereof. Therefore, it is intended that this disclosure not be limited to the particular exemplary embodiments disclosed for carrying out this disclosure, but that this disclosure will include all embodiments falling within the scope of the appended claims and their equivalents.

What is claimed is:

1. A mobile terminal, comprising:
a subscriber identification module (SIM) card unit to receive and store Internet Protocol (IP) device information comprising a local IP address of an IP device from a femtocell; and
a control unit to transmit a control command to the femtocell, the control command to control the IP device using the local IP address of the IP device.

2. The mobile terminal of claim 1, wherein the control unit transmits the control command for a position outside a coverage of the femtocell.

3. The mobile terminal of claim 1, wherein the control unit transmits the control command through communication with the femtocell.

4. The mobile terminal of claim 1, wherein the SIM card unit receives the IP device information from the femtocell through Short Message Service Point to Point (SMS-PP).

5. The mobile terminal of claim 1, wherein
the SIM card unit further stores an application toolkit, and
the control unit controls the information stored in the SIM card unit to be displayed using the application toolkit.

6. The mobile terminal device of claim 1, wherein
the IP device information further comprises control information of the IP device, and
the control unit transmits the control command using the control information of the IP device stored in the SIM card unit.

7. The mobile terminal of claim 1, wherein the SIM card unit updates the IP device information with updated IP device information received from the femtocell if a predetermined event occurs.

8. The mobile terminal of claim 1, wherein
the IP device information comprises a plurality of local IP addresses respectively corresponding to a plurality of IP devices, and
the control unit transmits the control command to control the IP device from among the plurality of IP devices according to a user selection.

9. A method for controlling an Internet Protocol (IP) device using a mobile terminal, comprising:
receiving IP device information comprising a local IP address of the IP device from a femtocell;
storing the IP device information in a subscriber identification module (SIM) card; and
controlling the IP device using the local IP address.

10. The method of claim 9, wherein the mobile terminal controlling the IP device is located outside a coverage of the femtocell.

11. The method of claim 9, wherein the IP device information is received by the mobile terminal through Short Message Service Point to Point (SMS-PP).

12. The method of claim 9, wherein controlling the IP device further comprises:
storing an application toolkit in the SIM card;
displaying the IP device information using the application toolkit; and
controlling the IP device using the local IP address and the displayed information.

13. The method of claim 9, wherein storing the IP device information in the SIM card further comprises updating the IP device information with updated IP device information received from the femtocell if a predetermined event occurs.

14. The method of claim 9, wherein storing the IP device information in the SIM card further comprises storing IP device information comprising a plurality of local IP addresses respectively corresponding to a plurality of IP devices from the femtocell, and controlling the IP device comprises controlling the IP device from among the plurality of IP devices according to a user selection.

15. A method for controlling an Internet Protocol (IP) device using a mobile terminal, comprising:
storing a local IP address of the IP device in a subscriber identification module (SIM) card;
retrieving the local IP address of the IP device; and
transmitting a control command to the femtocell, the control command to control the IP device using the local IP address.

16. The method of claim 15, wherein the control command comprises a command to initiate a data transfer between the mobile terminal and the IP device.

17. The method of claim 15, wherein the control command comprises a command to the IP device to print data transmitted from the mobile terminal.

18. The method of claim 15, wherein the control command comprises a command to initiate a data transfer between the IP device and a separate device.

19. The method of claim 15, wherein the control command is transmitted from the mobile terminal to the femtocell via a base station.
